(19) United States
(12) Patent Application Publication
(10) Pub. No.: US 2015/0053601 A1
(43) Pub. Date: Feb. 26, 2015

(54) MEMBRANE MODULE AND PROCESS FOR PRODUCING SAME

(71) Applicant: ASAHI KASEI CHEMICALS CORPORATION, Tokyo (JP)

(72) Inventors: Satoshi Shiki, Tokyo (JP); Takashi Itoh, Tokyo (JP); Kenzou Onizuka, Tokyo (JP); Teruhisa Yamada, Tokyo (JP)

(73) Assignee: ASAHI KASEI CHEMICALS CORPORATION, Tokyo (JP)

(21) Appl. No.: 14/388,366

(22) PCT Filed: Mar. 27, 2013
(86) PCT No.: PCT/JP2013/059065

§ 371 Date: Sep. 26, 2014

(30) Foreign Application Priority Data
Mar. 30, 2012 (JP) 2012-081600

(51) Int. Cl. B01D 63/02

(52) U.S. Cl. CPC B01D 63/023; B01D 63/02; B01D 2313/04
USPC 210/321.87; 156/330

(57) ABSTRACT

The membrane module according to the present invention comprises a tubular case, and a membrane fixed with a resin and accommodated in the state where filtered water is capable of being taken out from at least one end of the tubular case, in the tubular case, wherein the resin has an elution rate of chloride ions per unit surface area and per unit time of less than 10 μg/(m²·hr) in an elution test using hot water.

### TECHNICAL FIELD

The present invention relates to a membrane module which exhibits little elution from the membrane module when being used for filtration, and is suitable particularly for use in applications whose elution standards are strict, and a process for producing the membrane module.

### BACKGROUND ART

In production processes of ultrapure water used in semiconductor cleaning and the like, ultrafiltration membrane modules are used for removing microparticles right before use points. For ultrapure water, it is required to reduce the levels of not only microparticles but also soluble inorganic substances and organic substances. Therefore, in membrane modules used in ultrapure water-producing processes, it is necessary to reduce the elution of inorganic substances and organic substances from the membrane modules into ultrapure water.

Since the elution from a membrane having the largest liquid-contacting area is most problematic as an elution source from membrane modules, studies have been carried out mainly to reduce the elution from the membranes so far. Patent Literature 1 asserts that a raw material polymerized with a metallocene catalyst is used in order to suppress the elution from a filter used for ultrapure water. Patent Literature 2 asserts that a membrane is fabricated from a polyolefin containing no additives eluting inorganic substances or organic substances. Either thereof is a technology to reduce the elution from a membrane. Further Patent Literature 3 is directed to a process of reducing the elution by cleaning in advance in use of a membrane module.

### CITATION LIST

### Patent Literature

Patent Literature 1: W02005/84777 A

Patent Literature 2: JP 2010-234344 A

Patent Literature 3: JP 4296469 B

### SUMMARY OF INVENTION

### Technical Problem

Now, due to the recent year's advancement in the degree of integration of semiconductors, insulation faults due to the elution of chloride ions in a low concentration, which has not been taken as a problem conventionally, are considered as a problem, and thus it is required to reduce to a one-digit ng/L level. The Inventors' intensive studies for the reduction of the elution of chloride ions have revealed that not a membrane but an epoxy resin used for potting the membrane module is most associated with the elution of chloride ions from a membrane module. The initial elution from a potting resin layer of a membrane module can be reduced to some degree by cleaning as disclosed in Patent Literature 3. However, it has been found that since a potting resin layer usually has a thickness of 10 mm or more, it is not easy to completely clean the eluted components from the potting resin layer, and, as a result, a certain amount of the elution continues over a long period. In order to address such problems, the present inventors focused on the chloride ion elution property of a potting resin layer, and have found that the use of a resin having a low chloride ion-elution property can reduce the elution of chloride ions from a membrane module; and this finding has led to the present invention.

That is, the objective of the present invention is to provide a membrane module capable of achieving a low chloride ion-elution property, which cannot have been achieved by conventional membrane modules.

### Solution to Problem

In the elution from membrane modules, the elution from a membrane which has the largest liquid-contacting area has conventionally been considered a problem. The present inventors have carried out studies also on the elution from constituent materials other than the membrane, and have found that the reduction of the elution from a resin used for potting the membrane can largely reduce the elution from the membrane module, and this finding has led to the completion of the following invention.

That is, the present invention provides a membrane module comprising a tubular case and a membrane fixed with a resin and accommodated in the state where filtered water is capable of being taken out from at least one end of the tubular case, in the tubular case, wherein the resin has an elution rate of chloride ions per unit surface area and per unit time of less than 10 μg/(m²·hr) in an elution test using hot water. By using such a resin, a membrane module exhibiting very little elution of chloride ions can be achieved. Such a membrane module is suitable for applications to ultrapure water.

In the present invention, it is preferable that the tensile elastic modulus at 90° C. of a resin used in fixation of a membrane is 10 MPa or more and less than 600 MPa. The use of such a resin allows using in hot water, in which particularly the elution of chloride ions is taken as a problem. Further, it is preferable that the resin has an elution rate of TOC components (Total Organic Carbon) per unit surface area and per unit time of less than 200 μg/(m²·hr) in an elution test using hot water. In a membrane module for ultrapure water, in addition to the reduction of the elution of chloride ions, the reduction of the elution of organic substances is also important.

In the present invention, it is preferable that the membrane accommodated in the module is a hollow fiber membrane. The use of a hollow fiber membrane allows making the membrane area in the module large, and allows making large the production amount of ultrapure water per unit time even if the membrane is a membrane having the same rejection pore size.

In the present invention, it is preferable that a resin used for fixation of a membrane is composed of a cured substance of a thermosetting resin composition containing any one epoxy resin of bisphenol A type, bisphenol F type and phenol novolac type. The use of such an epoxy resin allows producing a membrane module having a low elution property. From a similar viewpoint, the resin may be a cured substance of a thermosetting resin composition containing an epoxy resin having been subjected to a treatment of reducing water-soluble components.

By using the membrane module according to the present invention, the increment of the chloride ion concentration contained in filtered water when hot pure water at 80° C. is filtered at a filtration rate per unit membrane area and per unit time of 294 L/(m²·hr) can be made to be 1 ng/L or less. The use of the membrane module can solve the problem of ultrapure water used in semiconductor manufacture.

### Advantageous Effects of Invention

The present invention can largely reduce the elution of chloride ions from a membrane module. The use of the membrane module according to the present invention can lead to the improvement of the purity of water and particularly to the improvement of the yield of semiconductor products produced using ultrapure water.

### BRIEF DESCRIPTION OF DRAWINGS

FIG. 1 is a cross-sectional diagram schematically showing one embodiment of the membrane module according to the present invention.

### DESCRIPTION OF EMBODIMENTS

Hereinafter, the embodiment according to the present invention will be described. A membrane module according to the present embodiment is suitable for producing ultrapure water in the fields using ultrapure water such as semiconductor manufacture processes, by further removing microparticle components from a primary pure water from which organic substances and ionic components have been removed. In the present application, ultrapure water means water from which impurities such as ionic components, organic substances and microparticles in the water have been removed as much as possible and which at least satisfies the specific resistance (or electric resistivity) at 25° C. of 18 MΩ·cm or more.

(Structure of a Membrane Module)

In the membrane module according to the present embodiment, a membrane is accommodated in a module case (tubular case). The accommodation state may be a structure in which the membrane is simultaneously fixed to the module case with a resin fixing the membrane (integrated type) or may be a structure in which a membrane unit in which the membrane is fixed together with a resin and other materials is fixed to the module case by using any sealing process (cartridge type). Although a method for taking out filtered water from the accommodated membrane may involve taking-out from one end of the case, or taking-out from both ends thereof, since in some cases of taking out from one end thereof, stagnation in the module interior is liable to occur and the cleanability of the module before use is worsened, a structure of taking out from both ends is preferable.

(Potting Resin)

The membrane module according to the present embodiment is characterized in that the resin used for fixation of the membrane has an elution rate of chloride ions per unit surface area and per unit time of less than 10 μg/(m²·hr) in an elution test using hot water. In the case where the elution rate of chloride ions is 10 μg/(m²·hr) or more, the elution to ultrapure water is large and it may not be used for manufacture of leading-edge semiconductors. A lower elution rate of chloride ions is better; 0.05 μg/(m²·hr) or more and less than 8 μg/(m²·hr) is preferable; and 0.4 μg/(m²·hr) or more and less than 5 μg/(m²·hr) is more preferable.

It is preferable that the tensile elastic modulus at 90° C. of the resin is 10 MPa or more and less than 600 MPa. The use of such a resin allows using in hot water too, in which particularly the elution of chloride ions is taken as a problem. In cases where the tensile elastic modulus is too low, the potting portion is deformed and so the exfoliation may occur at the interface with the case, or the membrane cannot follow the deformation of the potting portion and is broken. By contrast, in the case where the tensile elastic modulus is too high, breakage is liable to occur at the interface of the potting portion and the membrane. Therefore, from the viewpoint of hardly generating defects and making possible the long-period use of the membrane module, it is preferable that the elastic modulus is 50 MPa or more and less than 550 MPa, and 100 MPa or more and 500 MPa or less is more preferable.

Further, it is preferable that the resin has an elution rate of TOC components per unit surface area and per unit time of less than 200 μg/(m²·hr) in an elution test using hot water at 80° C. In a membrane module for ultrapure water, in addition to the reduction of the elution of chloride ions, also the reduction of the elution of organic substances is important. The elution rate of TOC components by the test of the potting resin is preferably less than 100 μg/(m²·hr), and more preferably less than 50 μg/(m²·hr); and the lower limit value is about 10 μg/(m²·hr) from the viewpoint of costs.

It is preferable that the potting resin is a cured substance of a thermosetting resin composition containing as a main component any one epoxy resin of bisphenol A type, bisphenol F type and phenol novolac type. The use of an epoxy resin containing such a phenol group in its skeleton allows producing a membrane module having a low elution property. Particularly in the case of requiring heat resistance, it suffices if a phenol novolac type easily taking a crosslinking structure in curing is used. From the viewpoint of suppressing the elution of chloride ions, the total chlorine amount in an epoxy resin to be used is preferably 500 ppm by mass or less, more preferably 300 ppm by mass or less, and still more preferably 150 ppm by mass or less. The lower limit value of the total chlorine amount of an epoxy resin is about 30 ppm by mass from the viewpoint of costs.

In the case of using a curing agent for curing an epoxy resin, the kind is not especially limited, but since the low elution property is demanded in applications to ultrapure water, use of curing agents of polyamideamine type is preferable. Further as the potting resin, urethane resins may be used.

In the case where the content of water-soluble components (chloride ions) in an epoxy resin to be used is high, the resin may be subjected to a treatment of reducing the water-soluble components in advance of use, and thereafter is used. In order to reduce chloride ions contained in an epoxy resin, for example, a process of refining the epoxy resin by using a metal alkoxide such as potassium tert-butoxide (t-BuOK) can be employed.

(Membrane)

In the present embodiment, it is preferable that the membrane accommodated in the module is a hollow fiber membrane. The use of a hollow fiber membrane allows making the membrane area in the module large and making large the production amount of ultrapure water per unit time even if the membrane is a membrane having the same rejection pore size. Since the use of a hollow fiber membrane in an external pressure filtration system allows producing a membrane module almost without opening the secondary side of the membrane in which filtered water flows, it is preferable that the membrane is a hollow fiber membrane also from the viewpoint of contamination with microparticles and microorganisms.

The material of the membrane is not especially limited as long as it has the heat resistance and exhibits little elution of organic substances and inorganic substances from the material itself Examples of materials excellent in the low elution property at high temperatures include polyolefin resins such as polyethylene and polypropylene, fluororesins such as polytetrafluoroethylene and polyvinylidene fluoride, and polysulfone-based resins such as polyether sulfone, polysulfone and polyphenyl sulfone. In order to make a membrane excellent in the removing performance of microparticles particularly in applications to ultrapure water, use of polysulfone-based resins, which are easily processed into membranes, is preferable.

(Production Process of the Membrane Module)

The membrane module according to the present embodiment can be fabricated as follows. First, as a resin for fixing the membrane, a resin whose elution rate of chloride ions per unit surface area and per unit time is less than 10 μg/(m²·hr) in an elution test using hot water is used.

When a thermosetting resin composition containing at least one epoxy resin selected from the group consisting of bisphenol A epoxy resins, bisphenol F epoxy resins and phenol novolac epoxy resins is used as a resin for fixing the membrane in the production process of the membrane module according to the present embodiment, the process comprises a step of curing the thermosetting resin composition.

In advance of use of the epoxy resin, the process can further comprise a step of subjecting the epoxy resin to a treatment of reducing water-soluble components. It is preferable that the treatment of reducing water-soluble components comprises a step of diluting the epoxy resin with a solvent to prepare an epoxy resin-diluted liquid, a step of adding a solution containing a metal alkoxide to the epoxy resin-diluted liquid, and thereafter adding water to phase-separate the epoxy resin-diluted liquid into an organic phase and a water phase, and a step of removing the water phase and thereafter removing the solvent from the organic phase. Thereby, since water-soluble components such as chloride ions are dissolved in the water phase, the total chlorine amount and the amount of the water-soluble components in the epoxy resin dissolved in the organic phase can be reduced.

(Elution Property from the Membrane Module)

According to the present embodiment, the increment of the chloride ion concentration contained in filtered water when hot pure water at 80° C. is filtered at a filtration rate per unit membrane area and per unit time of 294 L/(m²·hr) can be made to be 1 ng/L or less (1 ppt or less), and the quality of ultrapure water can be improved as compared with conventional ultrapure water. In order to make such a membrane module, it suffices if as members constituting the module, resins excellent in the heat resistance and exhibiting little elution are used as materials of housing and the membrane, and it suffices if a polysulfone-based resin or a fluororesin is used. As a resin used for fixing the membrane, it suffices if a resin whose elution rate per unit surface area and per unit time of chloride ions is less than 10 μg/(m²·hr) in an elution test using hot water is used.

(Hollow Fiber Membrane Module)

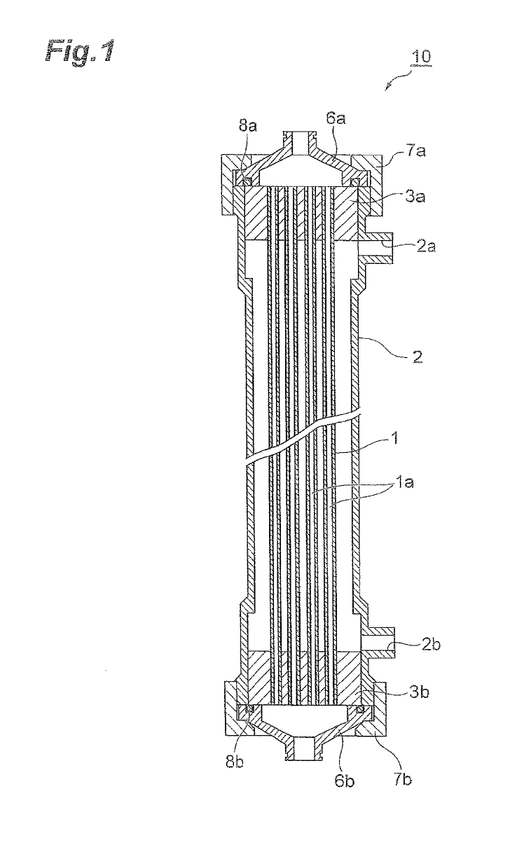

Hereinafter, an example (hollow fiber membrane module) of the membrane module for ultrapure water according to the present invention will be described by reference to FIG. 1. A hollow fiber membrane module 10 shown in FIG. 1 comprises a fiber bundle 1 composed of a large number of hollow fiber membranes 1 a, a tubular case 2 accommodating the fiber bundle 1, and a pair of potting portions 3a, 3b provided on both end portions of the fiber bundle 1 and composed of a cured substance of an epoxy resin. The module 10 is so configured that piping connection caps 6a, 6b can be installed on both ends of the tubular case 2 by nuts 7a, 7b. By tightening the nuts 7a, 7b, the portions are sealed with O-rings 8a, 8b disposed in grooves of the caps 6a, 6b.

The fiber bundle 1 is formed of a large number of hollow fiber membranes 1a. The kind of the hollow fiber membrane 1a can suitably be selected according to applications of the module 10. Specific examples of the hollow fiber membrane 1a include ultrafiltration membranes and microfiltration membranes. For example, in the case of using the module 10 for applications to final filters for ultrapure water, it is preferable that the hollow fiber membrane 1a is an ultrafiltration membrane having an average pore size of 0.05 μm or less (more preferably 0.02 μm or less).

The tubular case 2 is composed of a cylindrical member having openings on both ends, and has nozzles 2a, 2b installed in the vicinities of interfaces of the potting portions 3a, 3b. With respect to the size of the tubular case 2, it is preferable that the outer diameter is 140 to 200 mm, and the length is 700 to 1400 mm; and it is especially preferable that the outer diameter is 160 to 180 mm, and the length is 800 to 1100 mm. The use of the tubular case 2 in a size in this range allows a high module water-permeation amount and a highest module water-permeation performance to be achieved. In addition thereto, if the module 10 has this size, since the module 10 can be held by one person, the module 10 has an advantage that the handleability is remarkably good. The “outer diameter” used here of the tubular case 2 means an outer diameter of the cylinder in the filtration range of the center of the module. The “length” of the tubular case 2 means a distance between both end surfaces of the hollow fiber membranes 1a.

The potting portions 3a, 3b are composed of a resin sealing outer surfaces of the hollow fiber membranes 1a each other and gaps between the outer surfaces and the inner surface of the tubular case 2, on both end portions of the fiber bundle 1 in the tubular case 2. It is preferable that the potting portions 3a, 3b are composed of a cured substance of a thermosetting resin composition. By fixing and sealing both end portions of the fiber bundle 1 with the potting portions 3a, 3b, hollows of the hollow fiber membranes 1a open on both end surfaces of the fiber bundle 1.

In the case of using the hollow fiber membrane module 10 for an external pressure filtration system, water to be treated is supplied to the nozzle 2b; and filtered water is taken out from both ends (openings of the piping connection caps 6a, 6b) of the hollow fiber membrane module 10. On the other hand, water which has not passed through the hollow fiber membranes 1a is discharged from the nozzle 2a. Here, an integrated-type hollow fiber membrane module has been exemplified, but a hollow fiber membrane module may also be of a cartridge type as described above.

### EXAMPLES

Hereinafter, the present invention will be described more specifically by way of Examples and Comparative Examples, but the present invention is not limited to the following Examples.

(Measurement Method of the Total Chlorine Amount in an Epoxy Resin)

According to JIS K7246, an epoxy resin concerned was dissolved in diethylene glycol monobutyl ether; a 1N potassium hydroxide-propylene glycol solution was added thereto and the mixture was boiled for 20 min; and thereafter, a potentiometric titration with silver nitrate was carried out to determine a total chlorine amount.

(Elution Rate of Chloride Ions)

A cured epoxy resin or urethane resin was cut out into a plate shape of 4 mm in thickness; and the cut-out epoxy resin or urethane resin was immersed in hot water at 80° C. using ultrapure water of 1.5 ml per surface area of 1 cm² thereof to carry out pre-cleaning. The cleaning liquid used during 24 hours from the start of the immersion was discarded; and thereafter, the same amount of fresh ultrapure water was charged, and an elution test at 80° C. was started. The immersion was carried out for 5 days after the start, and the chloride ion concentration in the immersion liquid was measured by ion chromatography. By dividing the acquired chloride ion concentration by the surface area of the epoxy resin and the immersion time, an elution rate per unit surface area and per unit time of the epoxy resin or urethane resin was determined.

(Elution Rate of TOC Components)

Extraction of TOC components from an epoxy resin or urethane resin was carried out similarly to the above, and an elution rate was determined from the TOC concentration in the immersion liquid by using a TOC analyzer (made by Shimadzu Corp., TOC-5000A).

(Measurement of the Tensile Elastic Modulus)

A ES No.3 dumbbell (5 mm in width, 1 mm in thickness) according to JIS K6251 was fabricated using a resin concerned. The fabricated dumbbell was set on a tensile tester (made by Shimadzu Corp., AGS-5D); the sample atmosphere temperature was set at 90° C. using a temperature regulating chamber (made by Shimadzu Corp., TCH-220), and thereafter held at the temperature for 10 min to make the sample temperature to be 90° C. A tensile test was carried out and a tensile elastic modulus at 90° C. was determined.

### Test Example 1

100 parts by weight of a phenol novolac epoxy resin (DEN431, made by Dow Chemical Co.) whose total chlorine content was 2500 ppm by mass as an epoxy resin before refining, and 200 parts by weight of toluene were charged in a flask to dilute the epoxy resin. A solution in which t-BuOK of 7.5 equivalents to chlorine in the epoxy resin was diluted 10 times by NMP (N-methyl-2-pyrrolidone) was added thereto, and was allowed to react for 30 min in the state of being held at 40° C.; and thereafter, 100 parts by weight of water was added to terminate the reaction. In the state where an organic phase was diluted by further adding 200 parts by weight of toluene thereto, water-soluble components such as potassium chloride and t-BuOH produced in the reaction were extracted in a water phase, and then, the water phase was removed. The extraction with water was further carried out three times to remove water-soluble components; and thereafter, toluene was removed from the remaining organic phase by distillation to obtain a refined epoxy resin. It was confirmed that the total chlorine content in the epoxy resin decreased to 134 ppm.

The resin was allowed to react and cured with a polyamideamine-type curing agent (Sunmide 328, made by Air Products and Chemicals, Inc.), and cured at 90° C.; and thereafter, an epoxy resin plate was fabricated, and the elution test was carried out. As a result, the elution rate of chloride ions was 1.9 μg/(m²·hr), and the elution rate of TOC was 35.5 μg/(m²·hr). A measurement of the tensile elastic modulus at 90° C. using the resin cured similarly was carried out, and the tensile elastic modulus was 497 MPa. These results are summarized in Table 1 (also for subsequent Test Examples and Comparative Test Examples).

### Test Example 2

An epoxy resin was refined similarly to Test Example 1, except for using DEN431 whose total chlorine content was 2453 ppm as an epoxy resin before refining, and using t-BuOK of 10 equivalents to chlorine in the epoxy resin. The elution test was carried out similarly to Test Example 1 on an epoxy resin plate using the refined resin.

### Test Example 3

An epoxy resin was refined similarly to Test Example 1, except for using a phenol novolac epoxy resin (DEN438, made by Dow Chemical Co.) whose total chlorine content was 1996 ppm as an epoxy resin before refming. The elution test was carried out similarly to Test Example 1 on the epoxy resin plate using the refined resin.

### Test Example 4

A bisphenol F epoxy resin YL980 (made by Mitsubishi Chemical Corp.) whose total chlorine content was 300 ppm was used as an epoxy resin, and the elution test was carried out similarly to Test Example 1 on the epoxy resin plate.

### Test Example 5

A bisphenol A epoxy resin LX-01 (made by Daiso Co., Ltd.) whose total chlorine content was 30 ppm was used as an epoxy resin, and the elution test was carried out similarly to Test Example 1 on the epoxy resin plate.

### Test Example 6

A urethane resin plate was fabricated by not using an epoxy resin as a resin but mixing urethane resins KC462 and N4273 (both made by Nippon Polyurethane Industry Co., Ltd.) and reacting and curing the mixture, and the elution test was carried out similarly to Test Example 1.

### Comparative Test Example 1

The elution test was carried out similarly to Test Example 1, except for using the epoxy resin DEN431 used in Test Example 1 without refining the epoxy resin.

TABLE 1

| | | Test | Test | Test | Test | Test | Test | Comparative |
|---|---|---|---|---|---|---|---|---|
| | | Example 1 | Example 2 | Example 3 | Example 4 | Example 5 | Example 6 | Test Example 1 |
| Total Chlorine | Before | 2500 | 2453 | 1996 | 300 | 30 | — | 2500 |
| Amount of | Refining | | | | | | | |
| Epoxy Resin | After | 134 | 44 | 81 | — | — | — | — |
| (ppm by mass) | Refining | | | | | | | |

| | | | | | | | |
|---|---|---|---|---|---|---|---|
| Elution Rate of Chloride | 1.9 | 0.5 | 0.8 | 9.2 | 5.0 | 0.4 | 40.9 |
| Ions (μg/(m² · hr)) | | | | | | | |
| Elution Rate of TOC | 35.5 | 41.0 | 29.2 | 127 | 162 | 388 | 34.7 |
| (μg/(m² · hr)) | | | | | | | |
| Tensile Elastic Modulus | 497 | 512 | 553 | 380 | 355 | 20 | 503 |
| at 90° C. (MPa) | | | | | | | |

### Example 1

A membrane module was fabricated by using the epoxy resin used in Test Example 1. The effective filtration area of the membrane module was 34 m², and the filtration rate was 16 m³/hr in the case where pure water at 25° C. was filtered at a pressure of 100 kPa. Hot pure water at 80° C. was filtered using the membrane module at a filtration rate per unit membrane area and per unit time of 294 L (m²·hr), which corresponds to 10 m³/hr per module. After the lapse of 100 hours, sampling was carried out before and after the membrane module, and the increment of the chloride ion concentration due to the elution from the membrane module was measured, and was 0.6 ng/L.

### Comparative Example 1

A membrane module was fabricated similarly to Example 1, except for using the epoxy resin used in Comparative Test Example 1; and the elution test from the membrane module was carried out, and the increment of the chloride ion concentration due to the elution from the membrane module was 8 ng/L.

### INDUSTRIAL APPLICABILITY

The present invention can largely reduce the elution from a membrane module, which has been a problem with conventional modules for ultrapure water, particularly the elution amount of chloride ions, and can provide ultrapure water of a high purity. Therefore, also in manufacture of leading-edge semiconductors, the occurrence of product faults such as insulation faults due to the influence of elution substances can be suppressed.

### REFERENCE SIGNS LIST

1: fiber bundle, 1 a: hollow fiber membrane, 2: tubular case, 2a, 2b: nozzle, 3a, 3b: potting portions (resin), 6a, 6b: piping connection cap, 7a, 7b: nut, 8a, 8b: O-ring, 10: membrane module.

1. A membrane module, comprising:
a tubular case; and
a membrane fixed with a resin and accommodated in a state where filtered water is capable of being taken out from at least one end of the tubular case, in the tubular case,
wherein the resin has an elution rate of chloride ions per unit surface area and per unit time of less than 10 μg/(m²·hr) in an elution test using hot water.

2. The membrane module according to claim 1, wherein the resin has a tensile elastic modulus at 90° C. of 10 MPa or more and less than 600 MPa.

3. The membrane module according to claim 1, wherein the resin has an elution rate of TOC components per unit surface area and per unit time of less than 200 μg/(m²·hr) in an elution test using hot water.

4. The membrane module according to claim 1, wherein the membrane is a hollow fiber membrane.

5. The membrane module according to claim 1, wherein the resin is composed of a cured substance of a thermosetting resin composition containing any one epoxy resin of bisphenol A, bisphenol F and phenol novolac epoxy resins.

6. The membrane module according to claim 1, wherein the resin is composed of a cured substance of a thermosetting resin composition containing an epoxy resin having been subjected to a treatment of reducing water-soluble components.

7. A membrane module, wherein an increment of the chloride ion concentration contained in filtered water when hot pure water at 80° C. is filtered at a filtration rate per unit membrane area and per unit time of 294 L/(m²·hr) is 1 ng/L or less.

8. A process for producing a membrane module, the membrane module comprising: a tubular case; and a membrane fixed with a resin and accommodated in a state where filtered water is capable of being taken out from at least one end of the tubular case, in the tubular case,
wherein a resin having an elution rate of chloride ions per unit surface area and per unit time of less than 10 μg/(m²·hr) in an elution test using hot water is used as the resin for fixation of the membrane.

9. The process for producing a membrane module according to claim 8, wherein a thermosetting resin composition containing any one epoxy resin of bisphenol A type, bisphenol F type and phenol novolac type is used as the resin to fix the membrane, and the process comprises a step of curing the thermosetting resin composition.

10. The process for producing a membrane module according to claim 9, further comprising a step of subjecting the epoxy resin to a treatment of reducing water-soluble components in advance of use of the epoxy resin.

11. The process for producing a membrane module according to claim 10, wherein the treatment of reducing water-soluble components comprises:
a step of diluting the epoxy resin with a solvent to prepare an epoxy resin-diluted liquid;
a step of adding a solution containing a metal alkoxide to the epoxy resin-diluted liquid, and thereafter adding water to phase-separate the epoxy resin-diluted liquid into an organic phase and a water phase; and
a step of removing the water phase and thereafter removing the solvent from the organic phase.
